(19) United States
(12) Patent Application Publication
(10) Pub. No.: US 2016/0147577 A1
(43) Pub. Date: May 26, 2016

(54) SYSTEM AND METHOD FOR ADAPTIVE THREAD CONTROL IN A PORTABLE COMPUTING DEVICE (PCD)

(71) Applicant: QUALCOMM INCORPORATED, San Diego, CA (US)

(72) Inventors: JAMES MICHAEL ARTMEIER, BOULDER, CO (US); SUMIT SUR, BOULDER, CO (US); ROBERT S. DREYER, MENLO PARK, CA (US); MICHAEL D. SHARP, LOS GATOS, CA (US); JAMES L. ESLIGER, RICHMOND HILL (CA); WISLON KWAN, TORONTO (CA); CHRISTOS MARGIOLAS, SANTA CLARA, CA (US)

(21) Appl. No.: 14/553,243

(22) Filed: Nov. 25, 2014

(51) Int. Cl. G06F 9/52

(52) U.S. Cl. CPC G06F 9/52

(57) ABSTRACT

Systems and methods for adaptive thread control in a portable computing device (PCD) are provided. During operation a plurality of parallelized tasks for an application on the PCD are created. The application is executed with at least one processor of the PCD processing at least one main thread of the application. A determination is made whether a portion of the application being executed includes one or more of the parallelized tasks. A determination is made whether to perform the parallelized tasks in parallel. Based on the determination whether to perform the parallelized tasks in parallel, the parallelized tasks are executed with the at least one main thread of the application if the determination is not to perform the parallelized tasks in parallel, or if the determination is to perform the parallelized tasks in parallel, at least one worker thread is activated to execute the parallelized task in parallel with the main thread.

### DESCRIPTION OF THE RELATED ART

Devices with a processor that communicate with other devices through wireless signals, including portable computing devices (PCDs), are ubiquitous. These devices may include mobile cellular telephones, portable digital assistants (PDAs), portable game consoles, palmtop computers, and other portable electronic devices. In addition to the primary function of these devices, many include peripheral functions. For example, a mobile or cellular telephone may include the primary function of enabling and supporting telephone calls and the peripheral functions of a still camera, a video camera, global positioning system (GPS) navigation, web browsing, viewing videos, playing games, sending and receiving emails, sending and receiving text messages, push-to-talk capabilities, etc.

As the functionality of such devices increases there exists a need for greater computing power. Accordingly, modern PCDs typically include multiple processors or cores (e.g., central processing unit(s) (CPUs), video decoder, graphics processing unit(s) (GPU), modem processor, digital signal processor(s) (DSPs), etc.) for controlling or performing varying functions of the PCD. To take advantage of the increased number of processors/cores, applications and software executed by the PCD may be multi-threaded, allowing execution of portions of one or more application in parallel.

However, the presence of an increasing number of cores and/or CPUs as well as the increased number of applications designed to be multi-threaded can be problematic when these applications generate many threads trying to operate in parallel. Too many threads trying to operate on the multi-core or multi-processor PCD can degrade performance, increase power consumption unnecessarily, decrease battery life, etc., defeating the purpose of multi-threading.

Thus, there is a need for improved systems and methods to adaptively control threads in a PCD.

### SUMMARY OF THE DISCLOSURE

Systems and methods are disclosed for adaptive thread control in a portable computing device (PCD). During operation of the PCD a plurality of parallelized tasks for an application on the PCD are created. The application is executed with at least one processor of the PCD processing at least one main thread of the application. A determination is made whether a portion of the application being executed includes one or more of the parallelized tasks. A determination is made whether to perform the parallelized tasks in parallel. Based on the determination whether to perform the parallelized tasks in parallel, the parallelized tasks are executed with the at least one main thread of the application if the determination is not to perform the parallelized tasks in parallel, or if the determination is to perform the parallelized tasks in parallel, at least one worker thread is activated to execute the parallelized task in parallel with the main thread.

One example embodiment is a PCD including a central processing unit (CPU) containing a plurality of processors; and a memory in communication with the CPU, the memory storing: at least one application to be executed by the CPU, a plurality of parallelized tasks for the application, and a parallelism manager in communication with the at least one application, the parallelism manager comprising at least one queue in communication with logic configured to: determine whether a portion of the application being executed by the PCD includes one or more of the parallelized tasks, determine whether to perform the parallelized tasks in parallel, and if the determination is to perform the parallelized tasks in parallel, at least one worker thread is activated to execute the parallelized task in parallel with the main thread.

Additional embodiments of the systems and methods for adaptive thread control in a PCD are also provided.

### BRIEF DESCRIPTION OF THE DRAWINGS

In the drawings, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral to encompass all parts having the same reference numeral in all figures.

FIG. 1 is a block diagram of an example embodiment of a portable computing device (PCD) in which the present invention may be implemented;

FIG. 2 is a block diagram showing an exemplary embodiment of a system for providing adaptive thread control in a portable computing device PCD;

FIG. 3A is a flowchart describing an exemplary embodiment of a method for providing adaptive thread control in a PCD;

FIG. 3B illustrates example components capable of performing the method illustrated in FIG. 3A;

FIG. 4A is a flowchart describing another exemplary embodiment of a method for providing adaptive thread control in a PCD; and

FIG. 4B illustrates example components capable of performing the method illustrated in FIG. 4A.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files or data values that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer-readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the term “portable computing device” (“PCD”) is used to describe any device operating on a limited capacity rechargeable power source, such as a battery and/or capacitor. Although PCDs with rechargeable power sources have been in use for decades, technological advances in rechargeable batteries coupled with the advent of third generation (“3G”) and fourth generation (“4G”) wireless technology have enabled numerous PCDs with multiple capabilities. Therefore, a PCD may be a cellular telephone, a satellite telephone, a pager, a PDA, a smartphone, a navigation device, a smartbook or reader, a media player, a combination of the aforementioned devices, a laptop or tablet computer with a wireless connection, among others.

In this description, the terms “central processing unit (“CPU”),” “digital signal processor (“DSP”),” “graphics processing unit (“GPU”),” “chip,” “video codec,” “system bus,” “image processor,” and “media display processor (“MDP”)” are non-limiting examples of processing components that may benefit from the present systems and methods. These terms for processing components are used interchangeably except when otherwise indicated. Moreover, as discussed below, any of the above or their equivalents may be implemented in, or comprised of, one or more distinct processing components generally referred to herein as “core(s)” and/or “sub-core(s).”

In this description, the terms “workload,” “process load,” “process workload,” and “graphical workload” are used interchangeably and generally directed toward the processing burden, or percentage of processing burden, that is associated with, or may be assigned to, a given processing component in a given embodiment. Additionally, the related terms “frame,” “code block” and “block of code” are used interchangeably to refer to a portion or segment of a given workload. For instance, a graphical workload may be comprised of a series of frames, as would be understood by one of ordinary skill in the art of video processing. Further to that which is defined above, a “processing component” or the like may be, but is not limited to being, a central processing unit, a graphical processing unit, a core, a main core, a sub-core, a processing area, a hardware engine, etc. or any component residing within, or external to, an integrated circuit within a portable computing device.

One of ordinary skill in the art will recognize that the term “MIPS” represents the number of millions of instructions per second a processor is able to process at a given power frequency. In this description, the term is used as a general unit of measure to indicate relative levels of processor performance in the exemplary embodiments and will not be construed to suggest that any given embodiment falling within the scope of this disclosure must, or must not, include a processor having any specific Dhrystone rating or processing capacity. Additionally, as would be understood by one of ordinary skill in the art, a processor's MIPS setting directly correlates with the power, frequency, or operating frequency, being supplied to the processor.

The present systems and methods for a method for adaptive thread control in a PCD provide a cost effective ability to dynamically and adaptively determine whether to implement parallelization of tasks, such as by activating, waking, or implementing parallel worker threads, during the runtime of one or more applications. In an embodiment, the decision whether or not to implement the parallelization of the tasks may be based on the current capacity of one or more processors of a multicore central processing unit (CPU) to execute one or more threads and/or on the aggregate capacity of the CPU to execute one or more threads. In another embodiment, the decision whether or not to implement the parallelization of the task may be based on the volume or amount of parallelized tasks to be executed, such as by measuring parallelized tasks placed into one or more queues while awaiting execution.

In the present systems and methods, even if an application code, or a portion/region of an application code has been identified as advantageous for parallelization—whether during development of the application, during compiling or profiling of the application, or during runtime—parallelization of the application code may not be implemented at runtime based on the current conditions at the CPU, one or more cores of the CPU, volume of parallelized tasks to be processed, process priority, etc.

Thus, instead of automatically implementing parallelization by activating and/or providing tasks to parallel worker threads, such as a pool of worker threads created for a parallelized application, the present systems and methods adaptively determine whether or not to activate and/or use one or more worker threads for a particular interval. Thus, the present systems and methods allow for improved management of the parallel threads attempting to execute on a multi-core/multi-processor PCD. This management or control of the parallel threads improve performance of the cores/processors, reduces power consumption, and/or improves battery life by preventing unnecessary parallel threads/oversubscription to one or more cores/processors in the PCDs. Specifically, it more tightly binds the application, static build, and optional profile flow to the runtime scheduler to allow it to make intelligent decisions based on the state of the PCD.

One example embodiment is a PCD including a CPU with two or more cores/processors in communication with at least one memory. Stored in at least one memory is an operating system for operating and/or controlling the cores/processors, one or more applications that are being executed by the PCD, such as by sending tasks for execution by one or more of the cores/processors. Also stored in the memory is a parallelism manager or module in communication with the applications and the operating system. The exemplary parallelism manager includes one or more queues for holding parallelized tasks to be executed independently and/or in parallel by one or more worker threads. The exemplary parallelism manager also includes logic that may parallelize some or all of the code of the application, such as by compiling the code of the application. The exemplary parallelism manager also includes logic that may operate during the runtime to determine, or assist in determining, whether or not to implement the parallelization during runtime for a particular execution interval of the CPU.

Although described with particular reference to an operation within a PCD, the described systems and methods for adaptive thread control are applicable to any system with a processor, or processing subsystem where it is desirable to conserve power consumption, enhance performance, or improve quality of service. Stated another way, the described systems and methods may be implemented to provide adaptive thread control in a system other than a portable device.

The system and methods for adaptive thread control described herein, or portions of the system and methods, may be implemented in hardware or software. If implemented in hardware, the devices can include any, or a combination of, the following technologies, which are all well known in the art: discrete electronic components, an integrated circuit, an application-specific integrated circuit having appropriately configured semiconductor devices and resistive elements, etc. Any of these hardware devices, whether acting or alone, with other devices, or other components such as a memory may also form or comprise components or means for performing various operations or steps of the disclosed methods.

When a system or method described herein is implemented, or partially implemented, in software, the software portion can be used to automatically parallelize some or all of an application code, determine whether to implement the parallelization during runtime, and activate/implement worker threads as needed to execute the parallelized tasks based on the above determination.

The software and data used in representing various elements can be stored in a memory and executed by a suitable instruction execution system (microprocessor). The software may comprise an ordered listing of executable instructions for implementing logical functions, and can be embodied in any “processor-readable medium” for use by or in connection with an instruction execution system, apparatus, or device, such as a single or multiple-core processor or processor-containing system. Such systems will generally access the instructions from the instruction execution system, apparatus, or device and execute the instructions.

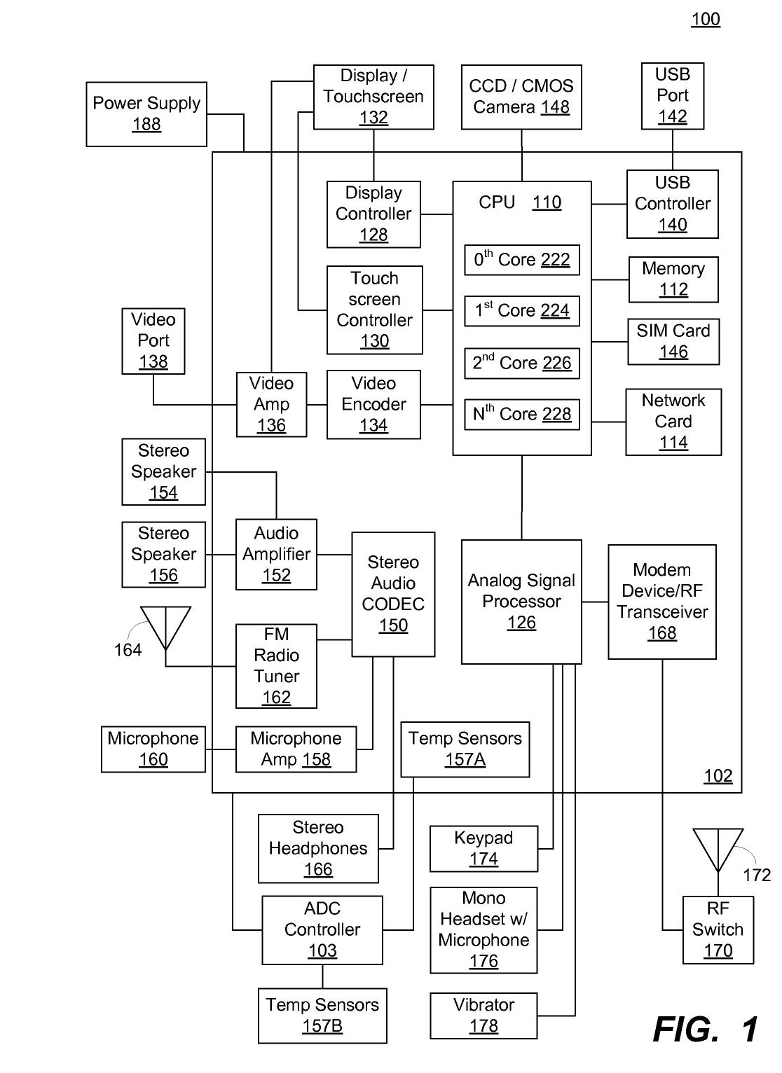

FIG. 1 is a block diagram of an exemplary, non-limiting aspect of a PCD 100 that may implement the present systems and methods in the form of a wireless telephone capable of communicating with one or more wireless communication system. Such wireless communication system may be a broadband wireless communication system, including a Long Term Evolution (LTE) system, a Code Division Multiple Access (CDMA) system, a Frequency Division Multiple Access (FDMA) system, a Global System for Mobile Communications (GSM) system, a wireless local area network (WLAN) system, some other wireless system, or a combination of any of these. A CDMA system may implement Wideband CDMA (WCDMA), CDMA 1×, Evolution-Data Optimized (EVDO), Time Division Synchronous CDMA (TD-SCDMA), or some other version of CDMA.

As shown, the PCD 100 includes an on-chip system 102 that includes a heterogeneous multi-core central processing unit (“CPU”) 110 and an analog signal processor 126 that are coupled together. The CPU 110 may comprise a zeroth core 222, a first core 224, a second core 226, and an Nth core 228 as understood by one of ordinary skill in the art. Further, instead of a CPU 110, a digital signal processor (“DSP”) may also be employed as understood by one of ordinary skill in the art. Moreover, as is understood in the art of heterogeneous multi-core processors, each of the cores 222, 224, 226, 228 may process workloads at different efficiencies under similar operating conditions. Each of the cores 222, 224, 226, 228 may control one or more function of the PCD 100. For example, the first core 224 may be a graphics processing unit (GPU) for controlling graphics in the PCD 100. Such GPU/first core 224 may further include drivers and/or other components necessary to control the graphics in the PCD 100, including controlling communications between the GPU core 326 and memory 112 (including buffers). For another example, a different core such as the Nth core 228 may control the camera 148 and such core 230 may further include drivers and/or other components necessary to control the camera 148, including communications between the Nth core 228 and memory 112 (including buffers).

As illustrated in FIG. 1, a display controller 128 and a touch screen controller 130 are coupled to the multicore CPU 110. In turn, a display/touchscreen 132, external to the on-chip system 102, is coupled to the display controller 128 and the touch screen controller 130.

The PCD 100 of FIG. 1 may further include a video encoder 134, e.g., a phase alternating line (PAL) encoder, a sequential couleur a memoire (SECAM) encoder, or a national television system(s) committee (NTSC) encoder, or any other type of video decoder 134 coupled to the multicore CPU 110. Further, a video amplifier 136 is coupled to the video encoder 134 and the display/touchscreen 132. A video port 138 is coupled to the video amplifier 136. As depicted in FIG. 1, a universal serial bus (USB) controller 140 is coupled to the multicore CPU 110. Also, a USB port 142 is coupled to the USB controller 140. A memory 112 and a subscriber identity module (SIM) card 146 may also be coupled to the multicore CPU 110. In other embodiments, multiple SIM cards 146 may be implemented.

A digital camera 148 may be coupled to the multicore CPU 110. As discussed above, in such embodiments, the digital camera 148 may be controlled by one of the cores of the multicore CPU 110. In an exemplary aspect, the digital camera 148 is a charge-coupled device (CCD) camera or a complementary metal-oxide semiconductor (CMOS) camera.

As further illustrated in FIG. 1, a stereo audio CODEC 150 may be coupled to the multicore CPU 110. Moreover, an audio amplifier 152 may be coupled to the stereo audio CODEC 150. In an exemplary aspect, a first stereo speaker 154 and a second stereo speaker 156 are coupled to the audio amplifier 152. FIG. 1 shows that a microphone amplifier 158 may be also coupled to the stereo audio CODEC 150. Additionally, a microphone 160 may be coupled to the microphone amplifier 158. In a particular aspect, a frequency modulation (FM) radio tuner 162 may be coupled to the stereo audio CODEC 150. Also, a FM antenna 164 is coupled to the FM radio tuner 162. Further, stereo headphones 166 may be coupled to the stereo audio CODEC 150.

FIG. 1 further indicates that a modem device/radio frequency (“RF”) transceiver 168 may be coupled to the multicore CPU 110. The modem device 168 may support one or more of the wireless communications protocols, such as GSM, CDMA, W-CDMA, TDSCDMA, LTE, and variations of LTE such as, but not limited to, FDB/LTE and PDD/LTE wireless protocols. Additionally, there may be multiple modem devices 168, and in such embodiments, different modem devices 168 may support come or all of the wireless communication protocols and/or technologies listed above.

In some implementations the modem device 168 may be further comprised of various components, including a separate processor, memory, and/or RF transceiver. In other implementations the modem device 168 may simply be an RF transceiver. Further, the modem device 168 may be incorporated in an integrated circuit. That is, the components comprising the modem device 168 may be a full solution in a chip. Additionally, various components comprising the modem device 168 may also be coupled to the multicore CPU 110. An RF switch 170 may be coupled to the modem device 168 and an RF antenna 172. In various embodiments, there may be multiple RF antennas 172, and each such RF antenna 172 may be coupled to the modem device 168 through an RF switch 170.

As shown in FIG. 1, a keypad 174 may be coupled to the multicore CPU 110 either directly, or through the analog signal processor 126. Also, a mono headset with a microphone 176 may be coupled to the multicore CPU 110 and or analog signal processor 126. Further, a vibrator device 178 may also be coupled to the multicore CPU 110 and/or analog signal processor 126. FIG. 1 also shows that a power supply 188 may be coupled to the on-chip system 102, and in some implementations the power supply 188 is coupled via the USB controller 140. In a particular aspect, the power supply 188 is a direct current (DC) power supply that provides power to the various components of the PCD 100 that require power. Further, in a particular aspect, the power supply 188 may be a rechargeable DC battery or a DC power supply that is derived from an alternating current (AC) to DC transformer that is connected to an AC power source.

The multicore CPU 110 may also be coupled to one or more internal, on-chip thermal sensors 157A as well as one or more external, off-chip thermal sensors 157B. The on-chip thermal sensors 157A may comprise one or more proportional to absolute temperature (“PTAT”) temperature sensors that are based on vertical PNP structure and are usually dedicated to complementary metal oxide semiconductor (“CMOS”) very large-scale integration (“VLSI”) circuits. The off-chip thermal sensors 157B may comprise one or more thermistors. The thermal sensors 157 may produce a voltage drop that is converted to digital signals with an analog-to-digital converter (“ADC”) controller 103. However, other types of thermal sensors 157 may be employed without departing from the scope of the invention.

FIG. 1 further indicates that the PCD 110 may also include a network card 114 that may be used to access a data network, e.g., a local area network, a personal area network, or any other network. The network card 114 may be a Bluetooth network card, a WiFi network card, a personal area network (PAN) card, or any other network card well known in the art. Further, the network card 114 may be incorporated in an integrated circuit. That is, the network card 114 may be a full solution in a chip, and may not be a separate network card 114.

As depicted in FIG. 1, the display/touchscreen 132, the video port 138, the USB port 142, the camera 148, the first stereo speaker 154, the second stereo speaker 156, the microphone 160, the FM antenna 164, the stereo headphones 166, the RF switch 170, the RF antenna 172, the keypad 174, the mono headset 176, the vibrator 178, and the power supply 180 are external to the on-chip system 102.

The on-chip system 102 may also include buses or interfaces and accompanying controllers (not shown). For example, a bus or interconnect communicatively couples the CPU 110 to components of a multimedia subsystem, including the video encoder 134. It should be understood that any number of buses and interconnects may be implemented in any configuration desired to allow the various components of the PCD 100 to communicate. Similarly, multiple bus or interconnect controllers may be arranged to monitor and manage the buses/interfaces of the on-chip system 102. Alternatively, a single bus/interface controller could be configured with inputs arranged to monitor two or more bus interfaces that communicate signals between CPU 110 and various subsystems of the PCD 100 as desired.

In a particular aspect, one or more of the method steps described herein may be enabled via a combination of data and processor instructions stored in the memory 112. These instructions may relate to applications, software, and/or code stored in the memory 112, or portions (such as threads) of such applications, software, and/or code. These instructions may be executed by one or more cores or processors in the multicore CPU 110 in order to perform the methods described herein. Further, the multicore CPU 100, one or more of the cores 222, 224, 226, 228, the memory 112, or a combination thereof may serve as a means for executing one or more of the method steps described herein in order enable adaptive thread control.

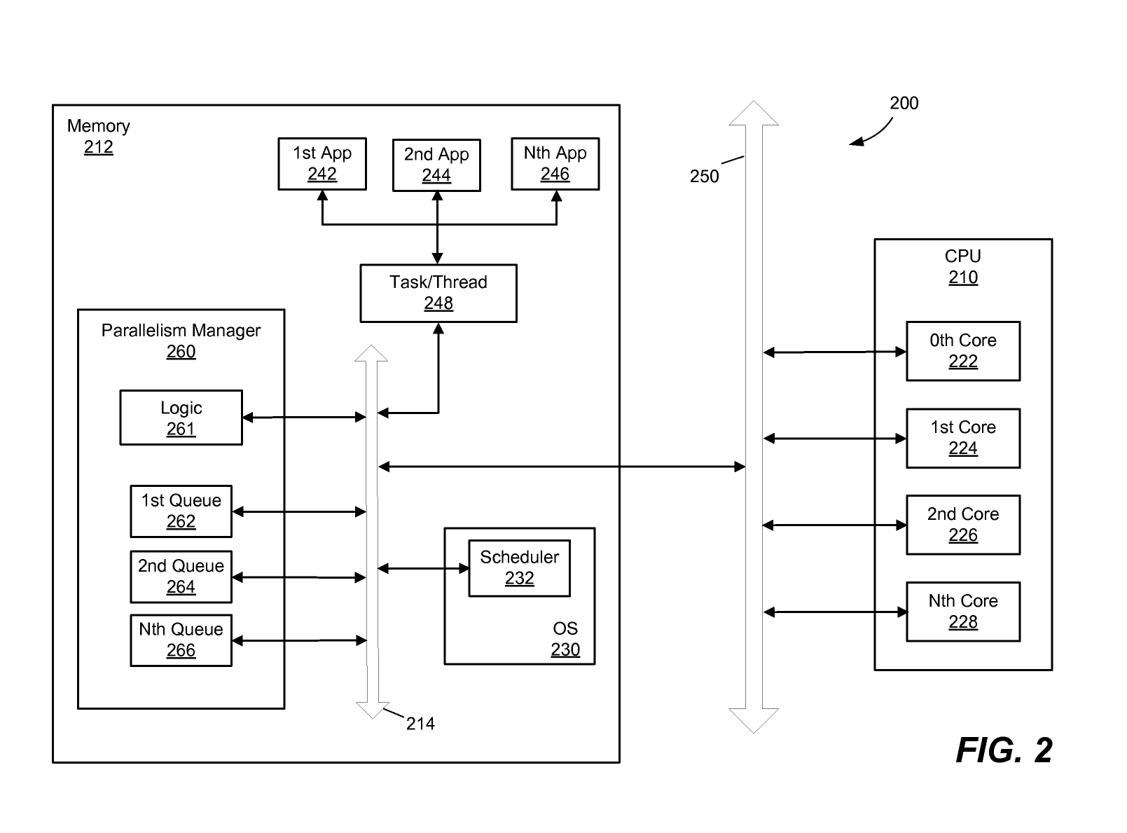

FIG. 2 is a block diagram showing an exemplary system 200 for supporting adaptive thread control in a PCD. Such adaptive thread control allows for, among other benefits, improved performance and improved power consumption management for processing components in the PCD. In the embodiment illustrated in FIG. 2, the system 200 includes a CPU 210 and a memory 212 in communication via interconnect 250. The system 200 may be a system-on-a-chip like SoC 102 of FIG. 1. Alternatively, one or more of the components illustrated for system 200 may be located on separate chips. CPU 210 shown in FIG. 2 is a multi-core/multi-processor CPU 210, such as the CPU 110 of FIG. 1. In the embodiment illustrated in FIG. 2, the CPU 210 comprises four processors or cores, zeroth core 222, first core 224, second core 226, and Nth core 228, which may be similar to the cores 222, 224, 226, 228 in a PCD 100 discussed above for FIG. 1. Although four cores 222, 224, 226, 228 are illustrated in the embodiment of FIG. 2 more or fewer cores/processors may be implemented in other embodiments as desired.

Each of the zeroth core 222, first core 224, second core 226, and Nth core 228 of FIG. 2 may be any type of processor or core including an application processor/core, a modem processor/core, a WiFi processor/core, a video decoder processor/core, an audio decoder processor/core, a GPU/graphics core, etc. In some embodiments, one or more of the cores 222, 224, 226, 228 may not be symmetric and/or homogeneous. Additionally, in an embodiment, one or more of the cores 222, 224, 226, 228 of FIG. 2 may include additional components not illustrated, such as a cache memory, a buffer memory, dynamic clock voltage scaling (DCVS) logic, etc. Each of cores 222, 224, 226, 228 and/or CPU 210 is communicatively coupled to interconnect 250. Interconnect 250 may be any desired interconnect, such as a bus, crossbars, etc. that allows processing instructions, data, signals, etc. to be communicated to and from the cores 222, 224, 226, 228 and/or the CPU 210.

Interconnect 250 is also coupled with memory 212 to allow communications between memory 212 and CPU 200. The memory 212 is illustrated in FIG. 2 as a single memory for simplicity. However, one of ordinary skill would understand that memory 212 may comprise multiple different memories, including partitions of a single physical memory and/or physically separated memories in communication such as via interconnect 250. Accordingly, one or more the “components” illustrated as part of/being stored in the memory 212 in FIG. 2 may be stored in a memory remotely located from the memory containing other components illustrated as being stored in the memory 212 in FIG. 2.

The illustrated memory 212 contains an operating system 230 for the CPU 210, which may be a high-level operating system (HLOS). The operating system 230 includes a scheduler 232 that operates to schedule delivery of instructions, code, data, tasks, threads, etc. to one or more of the cores 222, 224, 226, 228 of the CPU 210 for execution. The operating system 230 and/or scheduler 232 are in communication with memory interconnect 214 which allows communications between the various components of the memory 212 (or between the various memories), which may in some embodiments be the same bus or interconnect as interconnect 250, or may in other embodiments be a different bus or interconnect than interconnect 250.

Also stored in the memory 212 are one or more applications in communication with the operating system 230 and the multicore CPU 210. The applications are illustrated as first application 242, second application 244, and Nth application 246. The applications, 242, 244, 246 may comprise software, code, and/or instructions to be executed by the CPU 210 in order to perform some function on or for a PCD 100. For example, a first application 242 may comprise code for rendering graphics on a display of the PCD 100, while a second application 244 may comprise code or instructions to allow a user to enter data through a touchscreen of the PCD 100. Although three applications are illustrated in FIG. 2, it will be understood that fewer or many more applications may be stored in the memory 212 and/or operating on the PCD 100 at a given time. Furthermore, it will be understood that such applications may be background tasks such as a location tracker, a daemon or other executable software function with a process ID.

In an aspect, the applications 242, 244, 246 may each send one or more tasks/threads 248 to the operating system 230 to be processed at one or more of the cores 222, 224, 226, 228 within the multicore CPU 210. The tasks/threads 248 may be processed or executed as single tasks, threads, or a combination thereof. Further, the scheduler 232 may schedule these tasks, threads, or a combination thereof for execution with the multicore CPU 210 as instructed by the operating system 230.

Memory 212 also contains a parallelism manager 260 comprising logic 261 and one or more queues in communication with the operating system 230 and the applications 242, 244, 246. In the embodiment of FIG. 2, a first queue 262, second queue 264 and third queue 266 are illustrated. More or fewer than the three queues 262, 264, 266 may be implemented in other embodiments. As discussed below, the queues 262, 264, 266 may correspond to the applications 242, 244, 246 in an embodiment, and may function to hold tasks 248 that have been parallelized for parallel processing by more than one thread.

The Parallelism Manager 260 also includes logic 261 to assist parallelizing the applications 242, 244, 246 and/or to assist in adaptively controlling in threads executing the parallelized applications 242, 244, 246. As would be understood, the Parallelism Manager 260 may be one component as illustrated in FIG. 2 in some embodiments. In other embodiments, the Parallelism manager 260 may comprise separate components either co-located or located remotely from each other. In either case, one or more components of the Parallelism Manager 260, such as the logic 261 may also comprise multiple components or sub-components. For example in an embodiment, the Parallelism Manager 260 may comprise a compiler or other means to parallelize one or more of the applications 242, 246, 248. In such an embodiment, the logic 261 may comprise separate portions or separate sets of logic 261a and 261b (not shown) each of which may operate at different times such as at compile time and at run time, and/or may perform different functions.

Continuing the compiler example, the logic 261 may be adapted to identify portions of applications 242, 246, 248 that may be advantageous to execute in parallel and/or to compile or transform portions of the applications 242, 246, 248 into executable instructions or tasks 248 that may be run in parallel. In this example, applications 242, 244, 246 may comprise source, assembly and/or binary code where the main thread(s) of the application 242, 244, 246 are analyzed for parallel computation by the Parallelism Manager 260, regardless of whether the applications 242, 244, 246 have been designed for multi-threading. The portions of the applications 242, 244, 246 that are advantageous for parallel processing may be identified and/or flagged for parallel processing when the applications 242, 244, 246 are executed. Alternatively, the applications 242, 244, 246, or portions thereof may be compiled or translated into executable instructions or tasks 248, such as an intermediate representation, that is then executed in the place of the applications 242, 244, 246.

Similarly, the logic 261 either itself may be adapted or a separate logic 261b of the Parallelism Manager 260 may be adapted to operate during runtime of the parallelized tasks 248. Continuing with the above example, the runtime logic 261b or portion of logic 261 may, during runtime, adaptively determine whether or not actually execute the task in parallel, based on the current state and/or a determination that executing the parallelized tasks for one or more of the applications 242, 244, 246 in parallel would create excessive threads. If the decision is made to execute one or more of the parallelized tasks 248 in parallel, the parallelized tasks 248 may be placed into one or more of the queues 262, 264, 266 for processing by worker threads in parallel to the main application thread. Such worker threads may be executed by one or more of cores 222, 224, 226, 228 of the CPU 210.

In an embodiment the runtime portion of the logic 261/runtime logic 261b and/or the queues 262, 264, 266 may be a separate portion of the Parallelism Manager 260 from the portion of the logic 261/compile time logic 261a that determines whether an application 242, 244, 246 should be auto-parallelized into parallel tasks. By way of a non-limiting example, the Parallelism Manager 260 may comprise a compiler with the runtime logic 261b and/or queues 262, 264, 266 comprising a runtime library of the compiler that may be accessed and/or operated during execution of the applications 242, 244, 246. In other embodiments, the compile time and runtime portions/functions may be completely separate components in one or more memory 212 of the system 200.

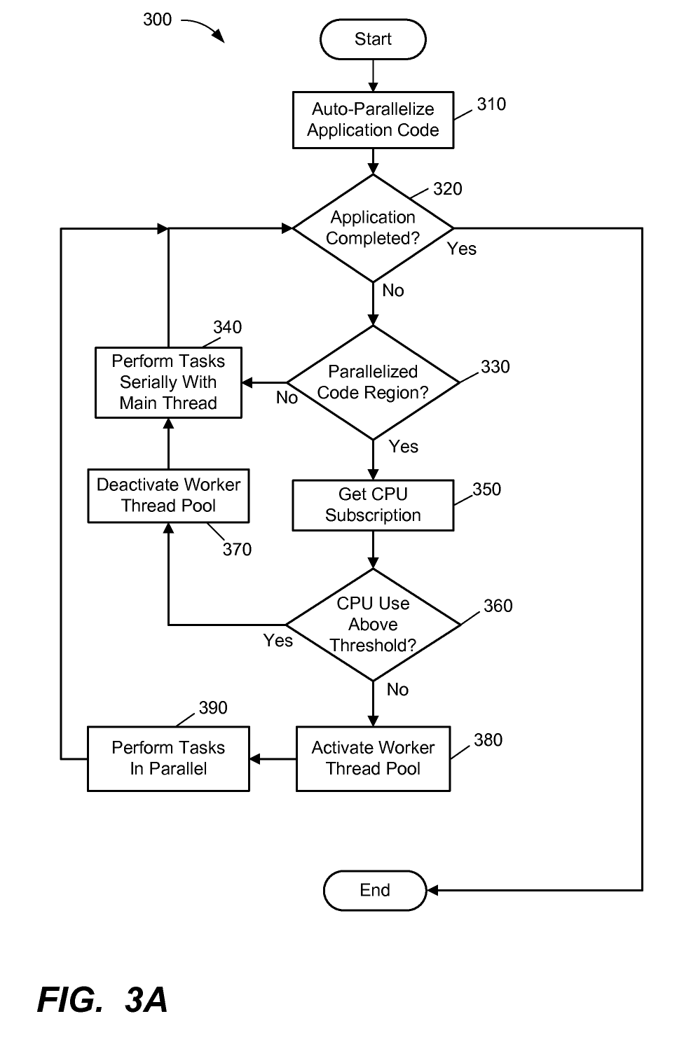

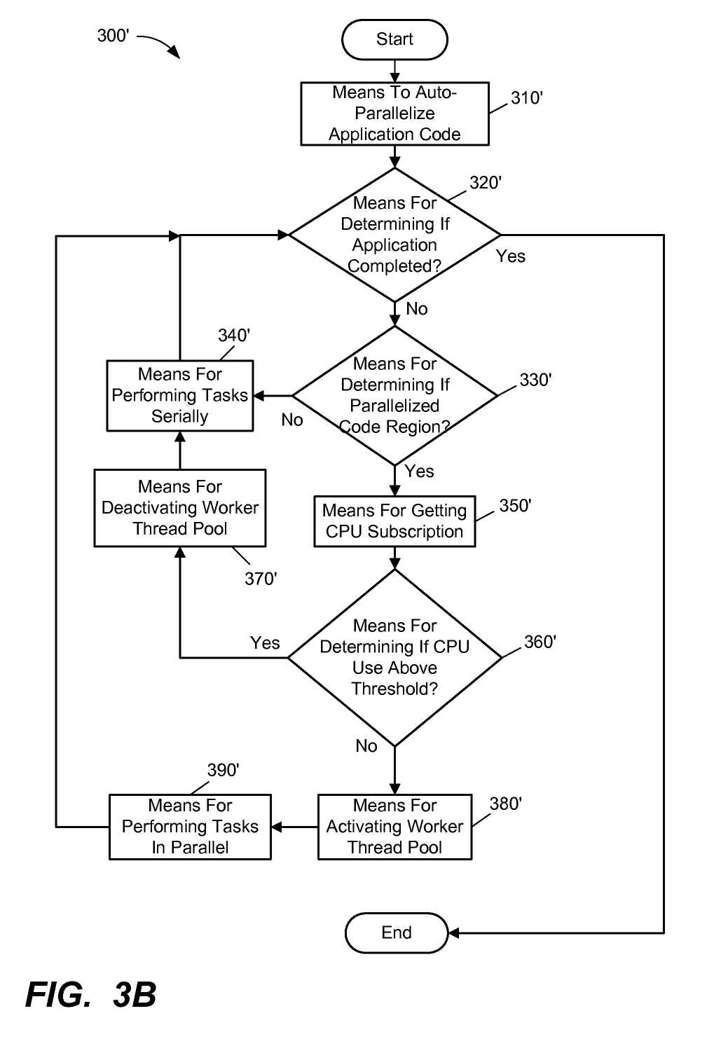

Referring now to FIG. 3A, a flowchart describing an exemplary embodiment of a method 300 for providing adaptive thread control in a PCD. The method 300 may be executed by a system such as system 200 shown in FIG. 2 for a PCD such as PCD 100 illustrated in FIG. 1.

In block 310 the code for one or more application is auto-parallelized. As discussed above this may comprise identifying a main thread for an application as well as portions or regions of the application code for which parallel processing or execution would be advantageous. Auto-parallelizing in block 310 may in some embodiments include identifying and flagging such portions or regions of the code. In other embodiments auto-parallelizing may include compiling or otherwise transforming an application's (or part of an application's) source, assembly, and/or binary code into parallelized code, instructions, or tasks that may be executed in parallel. Such parallel execution for the auto-parallelization of block 310 may be such that the parallel tasks are capable of execution by one or more secondary or worker threads on one or more processor, such as one or more cores 222, 224, 226, 228 of multi-core CPU 210 of FIG. 2.

In some embodiments auto-parallelization in block 310 may also comprise causing one or more worker threads for execution by one or more processor (such as cores 222, 224, 226, 228 of CPU 210 in FIG. 2) to be created when the application is executed. The number of worker threads may correspond to a degree or amount of parallelization in block 310, a degree or amount of multi-threading coded into the application during development, or may correspond to a number of processors or cores for the particular PCD. When multiple applications, such as applications 242, 244, 246 are operating on a PCD at the same time, each application 242, 244, 246 may have its own “pool” of worker threads created corresponding to that application 242, 244, 246 in some embodiments. Such worker threads may be continuously active, or may after periods of time, or periods of time without being assigned tasks to perform, enter varying low power or idle states. Thus, when the application operates, the pool of worker threads may be created, but entered into a low power, sleep, idle or other state until they are needed to perform parallelized tasks.

The method 300 continues in block 320 with the application executing on the PCD and a determination of whether or not the application is completed. In an embodiment the application may be one of applications 242, 244, 246 of FIG. 2 that is sending tasks 248 to the operating system 230. Determining whether the application is completed may comprise determining whether a main thread for the application has completed or otherwise ceased sending tasks to the operating system 230. If the application has completed, the method 300 ends. Determining whether the application is completed in block 320 may also comprised a periodic polling, such as at regular time intervals, to see if one or more application operating on the PCD has completed.

If the application has not completed, a determination is made in block 330 whether or not the current portion of the application to be executed comprises or is a parallelized code region or portion that was previously identified, such as in block 310 or prior to the method 300 operating such as when the application was developed. Such determination of block 330 may in some embodiments comprise recognizing or identifying portions of the application code that have been flagged as advantageous for parallel processing. Such determination of block 330 may in other embodiments comprise receiving tasks, such as tasks 248 from FIG. 2 that comprise parallelized code or instructions that have been created from the application code, such as by the Parallelism Manager 260 of FIG. 2.

If the determination at block 330 is that the portion or region of the code to be executed is not parallelized, then the method 300 proceeds to block 340 and the task, such as task(s) 248 for the application(s) 242, 244, 246 of FIG. 2 are processed serially, such as by a main thread for the application(s) 242, 244, 246. The method 300 then returns to block 320 to determine if the application is completed as described above.

If the determination in block 330 is that the portion or region of the application code to be executed is parallelized, then the method 300 proceeds to block 350 where a CPU subscription is obtained. Obtaining the CPU subscription in block 350 may comprise polling the operating system (such as operating system 230 of FIG. 2) for information about the current capacity of one or more processor/core of the PCD. In some embodiments, the CPU subscription information may be an aggregate value such as a busy percentage or other value indicating aggregate workload for all of the processors (such as cores 222, 224, 226, 228 of CPU 210 in FIG. 2) or simply an indication of which cores are powered on. In other embodiments the CPU subscription information may be an individualized indication of the workload or availability of each processor of the PCD. The CPU subscription information obtained in block 350 provides a current state for a particular time interval of the PCD's operation.

After the CPU subscription information is obtained, a determination is made in block 360 whether the current processor/core use or workload of the PCD is above a threshold value. This threshold value may in some implementations be related to aggregate processor/core workload or usage (such as in the case where the CPU subscription data is for the aggregate workload), or may be related to a workload or usage of individual processors/cores (such as where the CPU subscription data is per processor/core). The determination in block 360 may be made by comparing the CPU subscription information to a pre-determined value, such as a value stored in the Parallelism Manager 260 of FIG. 2 (for example when the Parallelism Manager 260 comprises a run-time library). The determination in block 360 may also be made analytically, such as by determining based on the CPU subscription information whether one or more processor/core is currently available to execute a worker thread (with the determination that no processor/core is available exceeding the threshold).

If the determination in block 360 is that the threshold is exceeded—e.g. there is little “headroom” on the CPU 210 and/or there is not a core 222, 224, 226, 228 currently available to execute a worker thread—the method proceeds to block 370 which deactivate the pool of worker threads for the application. In some embodiments, deactivating the pool of worker threads at block 379 may comprise not causing idle worker threads or worker threads in a low power state to power up, such as by not sending an alert or signal that such tasks have been placed in the queue 262, 264, 266 and/or an alert or signal such as to the operating system 230 to create or power up an inactive thread.

In other embodiments, the deactivation of the pool of worker threads in block 370 may comprise not providing tasks to any worker threads that may be in an awake or active state, such as by not putting or placing tasks or work in the queue 262, 264, 266 being polled by the active//awake worker threads. In such embodiments, any worker threads that are in an awake or active state for a period of time without having tasks assigned or available, will begin to shut down and/or enter one or more low power states. In yet other embodiments, deactivating the pool of worker threads may comprise sending a signal or otherwise causing one or more worker threads in the pool of worker threads to enter a low power, idle, or sleep state.

The end result of block 370 is that the method proceeds to block 340 where the main thread for the application 242, 244, 246 performs the tasks serially or sequentially rather than in parallel. Thus, even though the Parallelism Manager 260 and/or a software developer had determined that the task were appropriate for parallel execution, and even though it was determined to advantageous to process these tasks in parallel at compile time, the method 300 will cause the tasks to be performed for this time interval during runtime by the main thread rather than in parallel with worker threads based on the current state of the CPU subscriptions.

The method 300 then proceeds to block 320 where the method re-starts for a new time interval, determining first if the application is completed, and if not, whether the application is still in, or is in a new, parallelized code region.

Returning to block 360, of the method if the determination is that the threshold is not exceeded—e.g. there is sufficient “headroom” on the CPU 210 and/or there is one or more core 222, 224, 226, 228 currently available to execute a worker thread, the method proceeds to block 380 and activates the pool of worker threads. In an embodiment, activating the pool of worker threads in block 380 may comprise placing the tasks to be executed in parallel into one or more queues 262, 264, 266 that are being polled by worker threads, sending a signal or message to one or more of the cores 222, 224, 226, 228 that such work or tasks have been placed into one or more queues 262, 264, 266, and/or sending a message or signal such as a fast userspace mutex (futex) communication to operating system 230) to create or power up a worker thread in an inactive state.

The method 300 then proceeds to block 390 where the tasks are performed in parallel. Performing the parallelized tasks in parallel in block 390 may comprise one or more worker threads obtaining work from one or more of the queues 262, 264, 266 and being scheduled by the scheduler 232 of the operating system 230 for execution on one of the cores 222, 224, 226, 228 of the multicore CPU 210.

The method 300 then proceeds to block 320 where the method re-starts for a new time interval, determining first if the application is completed, and if not, whether the application is still in, or is in a new, parallelized code region. Thus for successive time intervals when the application code to be executed is a parallelized region or portion, the parallelized region may be executed sequentially or serially by the main thread in one time interval, but executed in parallel by one or more worker threads in additional to the main thread in a subsequent (or previous) time interval, based on the CPU subscription for the time interval.

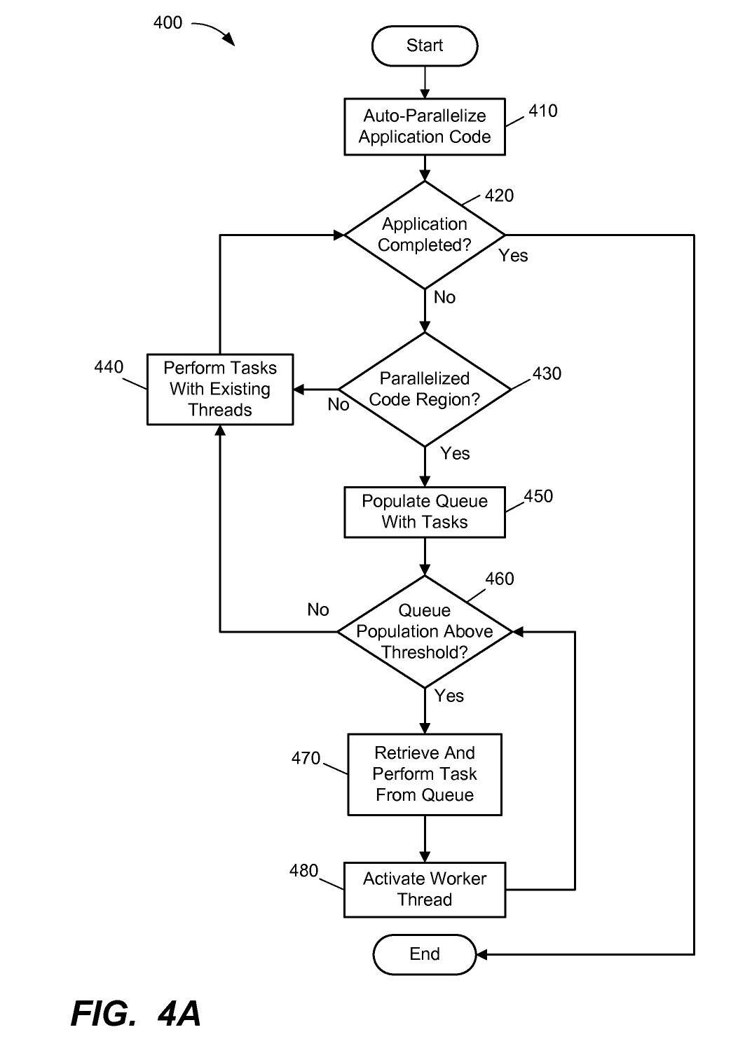

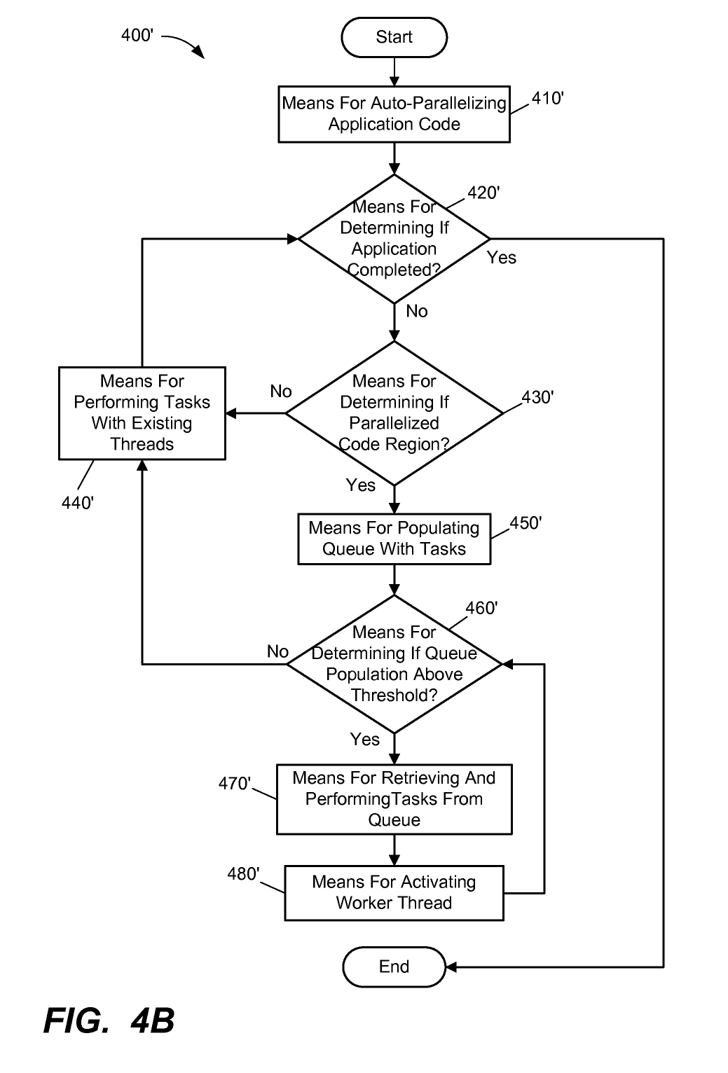

FIG. 4A illustrates a flowchart describing a second exemplary embodiment of a method 400 for providing adaptive thread control in a PCD. The method 400 may be executed by a system such as system 200 shown in FIG. 2 for a PCD such as PCD 100 illustrated in FIG. 1. Like the method 300 of FIG. 3, the method 400 begins in block 410 where the code for one or more application is auto-parallelized. As discussed above this may comprise identifying a main thread for an application as well as portions or regions of the application code for which parallel processing or execution would be advantageous. Auto-parallelizing in block 410 may in some embodiments include identifying and flagging such portions or regions of the code. In other embodiments auto-parallelizing may include compiling or otherwise transforming an application's (or part of an application's) source, assembly, and/or binary code into parallelized code, instructions, or tasks that may be executed in parallel. Such parallel execution for the auto-parallelization of block 310 may be such that the parallel tasks are capable of execution by one or more secondary or worker threads on one or more processor, such as one or more cores 222, 224, 226, 228 of multi-core CPU 210 of FIG. 2.

Similarly, block 420 (determining whether the application is completed), block 430 (determining whether the application code to be executed is a parallelized code region or portion), and block 440 (perform tasks with existing threads—e.g. the main thread(s) if the determination in block 430 is no) are the same as blocks 320, 330, and 340 of FIG. 3. The discussion of blocks 320, 330, and 340 of FIG. 3 above is equally applicable to blocks 420, 430, and 440 of the method 400 of FIG. 4.

However, unlike method 300 in method 400 if the determination in block 430 is that the portion or region of the application code to be executed is parallelized, then the method 400 proceeds to block 450 and populates one or more of queue 262, 264, 266 with the parallelized tasks or work for execution in parallel by one or more worker threads.

At block 460, the method 400 determines whether the population of the tasks in the queue 262, 264, 266 is above a threshold. This determination in block 460 may be analytical or may be a comparison to a threshold value stored somewhere, such as in Parallelism Manager 260 of FIG. 2 and may be a comparison of the number of tasks in the queue 262, 264, 266, the types of tasks in the queue 262, 264, 266, how long or more tasks have been in the queue 262, 264, 266, or the any other desired value related to the tasks or workload in the queue.

If the determination at block 460 is that the population of the tasks in the queue 262, 264, 266 is not above the threshold, then the method 400 continues to block 440 and performs the tasks with the existing/currently active threads. At some time intervals, only the main thread may be existing/currently active for the application. In that instance, the main thread will perform the tasks (i.e. perform the tasks in serial or sequentially) and the method returns to block 420 to determine if the application has completed (as discussed above for block 320 of FIG. 3).

If the determination at block 460 is that the population of the tasks in the queue 262, 264, 266 is above the threshold, then the method 440 continues to block 470 and the existing thread(s) retrieve a task from the queue 262, 264, 266 for execution/performance and proceed to block 480 where a worker thread is activated. The activation of the worker thread in block 480 is the activation of an additional worker thread in response to the determination in block 460 that sufficient tasks or work exists in the queue 262, 264, 266 to support an additional worker thread beyond the current number of threads executing the tasks in the queue 262, 264, 266. The additional thread can be wakened in block 480 by any means desired, such as by sending a signal or message to one or more of the cores 222, 224, 226, 228 that such work or tasks have been placed into one or more queues 262, 264, 266 and/or sending a message or signal such as a futex communication to operating system 230) to create or power up a worker thread in an inactive state.

Once the additional worker thread is pulled out of an idle or low power state, or awakened from a sleep state, the method 400 returns to block 460 and determines whether the population of work/tasks in the queue 262, 264, 266 is above the threshold for the new number of active threads in the same manner discussed above for block 460. If the second determination at block 460 is no then the method proceeds to block 440 and the existing/currently active threads for the application (a main thread and one worker thread in this example) perform their respective tasks in parallel.

If the second determination at block 460 is yes then the method proceeds to block 470 and the currently existing or active threads for the application (a main thread and one worker thread in this example) each retrieve a task from the queue 262, 264, 266 for execution. The method proceeds to block 480 where a second worker thread is activated in the same manner as discussed above for block 480. The method then returns to block 460 for the next iteration of the determination of whether the population of work/tasks in the queue 262, 264, 266 is above the threshold for the new number of active threads for the application.

The blocks of 460-480 may in some embodiments be allowed to iterate and wake/activate additional worker threads as long as the number/population of parallelized tasks in the queue 262, 264, 266 will support an additional worker thread. In other embodiments, part of the determination in block 460 may be a determination whether a maximum number of threads for an application have been activated. Once the desired number of threads have been opened with the iterations of blocks 460-480, the active/currently existing threads execute their respective tasks in parallel in block 440 and the method returns to block 420 to determine if the application has completed.

In the next iteration of the method 400, the determination at block 430 may be that the current region or portion of the application code is not parallelized, even though one or more worker threads may be awake/activated. As illustrated in the method 400, the block in that event would move to block 440 without populating the queue 262, 264, 266 with any parallelized tasks. With no tasks in the queues 262, 264, 266 being polled by the active/awake worker threads, these worker threads will at some point deactivate and/or enter into one or more lower power states.

Similarly, since the method 400 in this example will not have populated the queue 262, 264, 266 with any parallelized tasks, there will be no parallel execution and the performance of the task(s) in this iteration of block 440 will be by the main thread (i.e. performing the task(s) serially or sequentially) until the next time that the method determines that the region of the application code to be executed is parallelized (block 430) or until the application has completed execution (block 420) in which case the method 400 ends.

Thus the embodiment of FIG. 4 provides an alternative method 400 for providing adaptive thread control in a PCD. The method in FIG. 4 does not makes its determinations of whether to wake/activate additional worker thread(s) on the capacity of the CPU 210 and/or cores 222, 224, 226, 228 of the CPU 210, but instead makes the determination based on the amount of tasks/the workload of parallelized tasks populating the queues 262, 264, 266. Additionally, rather than immediately waking up/activating the entire pool of threads for the application, method 400 wakes/activates additional threads iteratively based on the amount of work/number of tasks available in the queues 262, 264, 266 to support each successively awakened/activated thread.

FIGS. 3A and 4A describe only two exemplary embodiments of method for providing adaptive thread control in a PCD. In other embodiments, additional blocks or steps may be added to one or more of methods 300 and/or 400. Similarly, in some embodiments various blocks or steps shown in FIG. 3A or 4A may be combined or omitted, such as for example combining blocks 322 and 330/420 and 430 into one determining block/step rather than the two separate determining blocks/steps illustrated in FIGS. 3A and 4A. Such variations of the methods 300 and 400 are within the scope of this disclosure.

Additionally, certain steps in the processes or process flows described in this specification naturally precede others for the invention to function as described. However, the invention is not limited to the order of the steps described if such order or sequence does not alter the functionality of the invention. Moreover, it is recognized that some steps may performed before, after, or in parallel (substantially simultaneously) with other steps without departing from the scope of the invention. In some instances, certain steps may be omitted or not performed without departing from the invention. Further, words such as “thereafter”, “then”, “next”, “subsequently”, etc. are not intended to limit the order of the steps. These words are simply used to guide the reader through the description of the exemplary method.

The various operations and/or methods described above may be performed by various hardware and/or software component(s) and/or module(s), and such component(s) and/or module(s) may provide the means to perform such operations and/or methods. Generally, where there are methods illustrated in Figures having corresponding counterpart means-plus-function Figures, the operation blocks correspond to means-plus-function blocks with similar numbering. For example, blocks 310-390 illustrated in FIG. 3A correspond to means-plus-function blocks 310′-390′ illustrated in FIG. 3B. Similarly, blocks 410-480 illustrated in FIG. 4A correspond to means-plus-function blocks 410′-480′ illustrated in FIG. 4B.

Additionally, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed processor-enabled processes is explained in more detail in the above description and in conjunction with the drawings, which may illustrate various process flows.

In one or more exemplary aspects as indicated above, the functions described may be implemented in hardware, software, firmware, or any combination thereof. If implemented in software, the functions may be stored on or transmitted as one or more instructions or code on a computer-readable medium, such as a non-transitory processor-readable medium. Computer-readable media include both data storage media and communication media including any medium that facilitates transfer of a program from one location to another.

A storage media may be any available media that may be accessed by a computer or a processor. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of non-transitory computer-readable media.

Although selected aspects have been illustrated and described in detail, it will be understood that various substitutions and alterations may be made herein without departing from the present invention, as defined by the following claims.

What is claimed is:

1. A method for adaptive thread control in a portable computing device (PCD), the method comprising:
creating a plurality of parallelized tasks for an application on the PCD;
executing the application with at least one processor of the PCD processing at least one main thread of the application;
determining whether a portion of the application being executed by the PCD includes one or more of the parallelized tasks;
determining whether to perform the parallelized tasks in parallel; and
based on the determination whether to perform the parallelized tasks in parallel:
executing the parallelized tasks with the at least one main thread of the application if the determination is not to perform the parallelized tasks in parallel, or
activating at least one worker thread to execute at least one of the parallelized tasks if the determination is to perform the parallelized tasks in parallel.

2. The method of claim 1, wherein determining whether to perform the parallelized tasks in parallel comprises:
obtaining a CPU subscription for a plurality of processors of the PCD.

3. The method of claim 2, wherein the CPU subscription comprises information about an aggregate workload of the plurality of processors of the PCD.

4. The method of claim 2, wherein activating at least one worker thread to execute at least one of the parallelized tasks comprises activating a pool of worker threads associated with the application.

5. The method of claim 1, further comprising:
populating at least one queue with at least some of the plurality of parallelized tasks for the application on the PCD.

6. The method of claim 5, wherein determining whether to perform the parallelized tasks in parallel comprises:
determining whether an amount of the plurality of parallelized tasks in the at least one queue exceeds a threshold.

7. The method of claim 6, further comprising:
activating at least a second worker thread to execute at least one of the parallelized tasks if the determination is to perform the parallelized tasks in parallel.

8. The method of claim 1, wherein activating at least one worker thread further comprises:
sending a fast userspace mutex (futex) communication to an operating system of the PCD.

9. A system for adaptive thread control in a portable computing device (PCD):
a central processing unit (CPU) containing a plurality of processors; and
a memory in communication with the CPU, the memory storing:
at least one application to be executed by the CPU,
a plurality of parallelized tasks for the application, and
a parallelism manager in communication with the at least one application, the parallelism manager comprising at least one queue in communication with logic configured to:
determine whether a portion of the application being executed by the PCD includes one or more of the parallelized tasks,
determine whether to perform the parallelized tasks in parallel, and,
activate at least one worker thread to execute at least one of the parallelized tasks if the determination is to perform the parallelized tasks in parallel.

10. The system of claim 9, wherein:
the parallelism manager comprises a run time library of a compiler.

11. The system of claim 10, wherein the determination whether to perform the parallelized tasks in parallel is based on a CPU subscription for the plurality of processors.

12. The system of claim 11, wherein the CPU subscription comprises information about an aggregate workload of the plurality of processors.

13. The system of claim 12, wherein the at least one worker thread comprises a pool of worker threads associated with the application.

14. The system of claim 9, wherein the parallelism manager further comprises at least one queue, the at least one queue populated with at least some of the plurality of parallelized tasks for the application.

15. The system of claim 9, wherein the determination whether to perform the parallelized tasks in parallel comprises:
a determination whether an amount of the plurality of parallelized tasks in the at least one queue exceeds a threshold.

16. The system of claim 15, wherein the logic is further configured to:
activate at least a second worker thread to execute at least one of the parallelized tasks if the determination is to perform the parallelized tasks in parallel.

17. A computer program product comprising a non-transitory computer usable medium having a computer readable program code embodied therein, said computer readable program code adapted to be executed to implement a method adaptive thread control in a portable computing device (PCD), the method comprising:
creating a plurality of parallelized tasks for an application on the PCD;
executing the application with at least one processor of the PCD processing at least one main thread of the application;
determining whether a portion of the application being executed by the PCD includes one or more of the parallelized tasks;
determining whether to perform the parallelized tasks in parallel; and
based on the determination whether to perform the parallelized tasks in parallel:
executing the parallelized tasks with the at least one main thread of the application if the determination is not to perform the parallelized tasks in parallel, or
activating at least one worker thread to execute at least one of the parallelized tasks if the determination is to perform the parallelized tasks in parallel.

18. The computer program product of claim 17, wherein determining whether to perform the parallelized tasks in parallel comprises:
obtaining a CPU subscription for a plurality of processors of the PCD.

19. The computer program product of claim 18, wherein the CPU subscription comprises information about an aggregate workload of the plurality of processors of the PCD.

20. The computer program product of claim 18, wherein activating at least one worker thread to execute at least one of the parallelized tasks comprises activating a pool of worker threads associated with the application.

21. The computer program product of claim 17, further comprising:
populating at least one queue with at least some of the plurality of parallelized tasks for the application on the PCD.

22. The computer program product of claim 21, wherein determining whether to perform the parallelized tasks in parallel comprises:
determining whether an amount of the plurality of parallelized tasks in the at least one queue exceeds a threshold.

23. The computer program product of claim 22, further comprising:
activating at least a second worker thread to execute at least one of the parallelized tasks if the determination is to perform the parallelized tasks in parallel.

24. A system for adaptive thread control in a portable computing device (PCD), the system comprising:
means for creating a plurality of parallelized tasks for an application on the PCD;
means for executing the application with at least one processor of the PCD processing at least one main thread of the application;
means for determining whether a portion of the application being executed by the PCD includes one or more of the parallelized tasks;
means for determining whether to perform the parallelized tasks in parallel; and
based on the determination whether to perform the parallelized tasks in parallel:
means for executing the parallelized tasks with the at least one main thread of the application if the determination is not to perform the parallelized tasks in parallel, or
means for activating at least one worker thread to execute at least one of the parallelized tasks if the determination is to perform the parallelized tasks in parallel.

25. The system of claim 24, wherein the means for determining whether to perform the parallelized tasks in parallel comprises:
means for obtaining a CPU subscription for a plurality of processors of the PCD.

26. The system of claim 25, wherein the CPU subscription comprises information about an aggregate workload of the plurality of processors of the PCD.

27. The system of claim 25, wherein the means for activating at least one worker thread to execute at least one of the parallelized tasks further comprises means for activating a pool of worker threads associated with the application.

28. The system of claim 24, further comprising:
means for storing for execution at least some of the plurality of parallelized tasks for the application on the PCD.

29. The system of claim 28, wherein the means for determining whether to perform the parallelized tasks in parallel comprises:
determining whether an amount of the plurality of parallelized tasks exceeds a threshold.

30. The system of claim 24, further comprising:
means for activating at least a second worker thread to execute at least one of the parallelized tasks if the determination is to perform the parallelized tasks in parallel.
